(19) United States
(12) Patent Application Publication
(10) Pub. No.: US 2005/0150727 A1
(43) Pub. Date: Jul. 14, 2005

(54) Door operator for elevators with selectable opening lengths, speed and side

(76) Inventor: Steven Leo Company, Deerfield Beach, FL (US)

Correspondence Address: Steven L. Company, 3413 Tuscany Way, Boynton Beach, FL, 33435, US

(21) Appl. No.: 10/755,508

(22) Filed: Jan. 12, 2004

(51) Int. Cl. B66B 13/02

(52) U.S. Cl. 187/313

(57) ABSTRACT

The door operator for elevators is useful for [36″; 42″ and 48″] of opening Length, also you select the opening side [right or left]. This way you reduce inventory ,because this design enables the door operator To have several combinations instead of one of each.

### BACKGROUND OF THE INVENTION

The invention relates to reduce inventory or stock of door operators for elevators The door operator parts where design to be selectable for different opening Lengths and opening side [right or left ] The opening lengths [36″; 42″ or 48″] are standard elevator lengths depending on the quantity of passengers a elevator takes. This really helps a elevator company to be competitive by reducing the amount of door operators that are not selectable . You can replace six with one in your inventory and reduce also space to store the stock.[36″; 42″ or 48″]×[ right or left ]=6 different combinations.

### SUMMARY OF THE INVENTION

According to the present invention the door operator for elevator use. Has a [part 1 , see drawings] with several holes design to assemble the [part 3, see drawings] this part is necessary to assemble the arm that connects to the clutch ,also the part is selectable depending on the length you need [36″; 42″ or 48″] This [part 3] is screw to [part 1] once the opening length is selected. Then [part 2, see drawings] is connected to the belt and the cab door hanger. This selectable door operator for only elevator use is great to reduce inventory and space for them, there are six different combinations you can select on the Parts [36″; 42″; 48″]×[right or left]=6.

### BRIEF DESCRIPTION OF THE DRAWINGS

FIG. 1 Are the dimensions of [part 1]; [part 2]; [part 3] and bumper In accordance with the present invention.

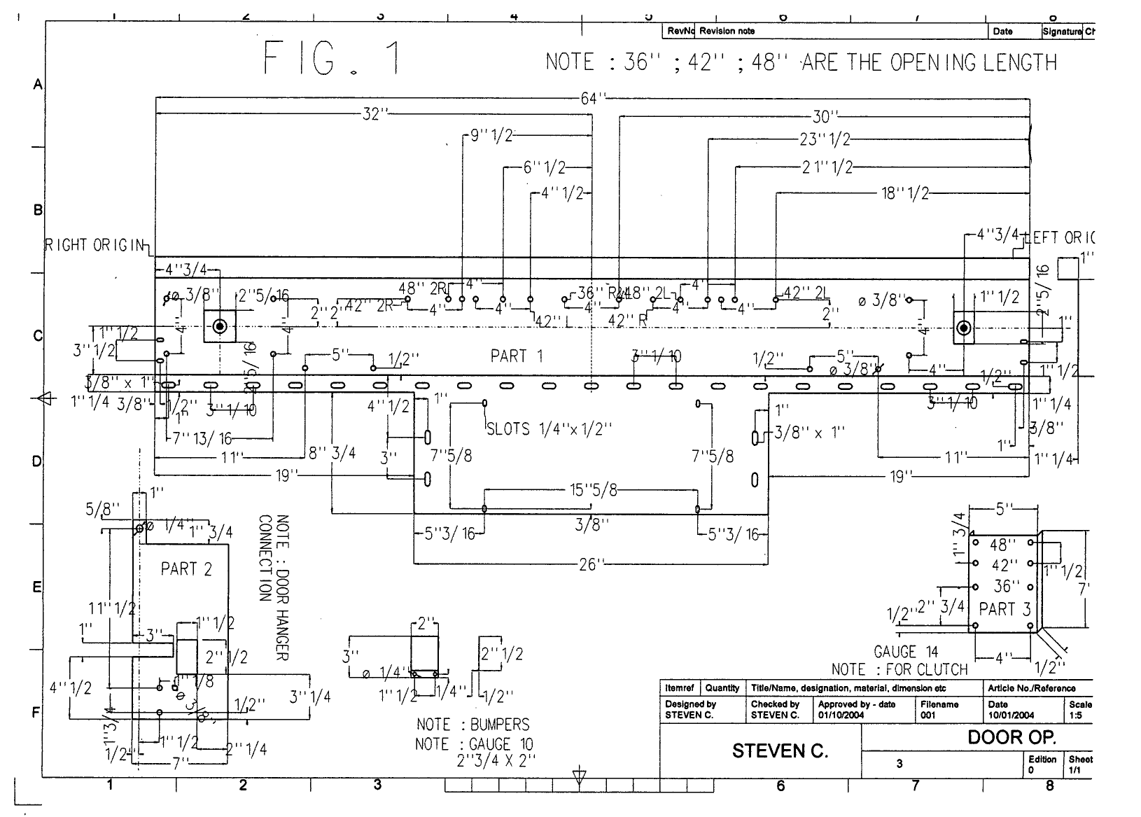

FIG. 2 is where [part 3] is screw to [part 1] depending on the selected opening Length, side and speed.

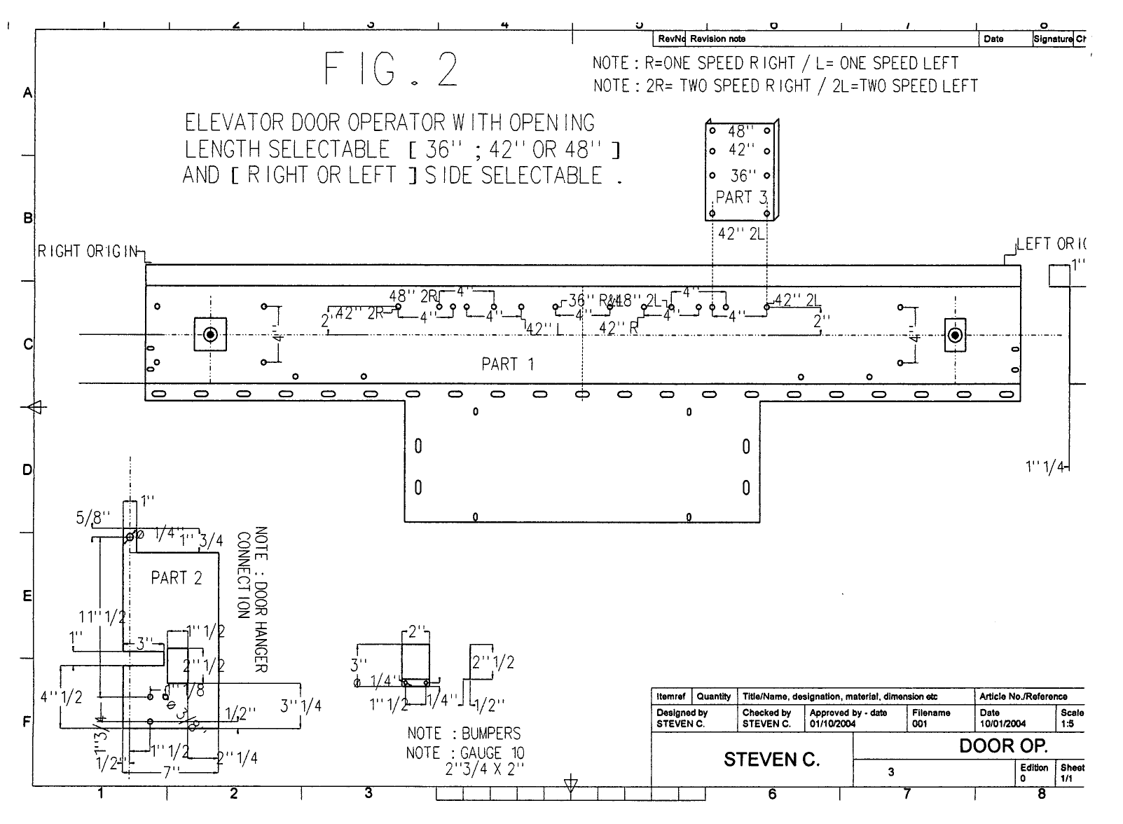

FIG. 3 is how [part 2] is connected to the belt and the car door hanger

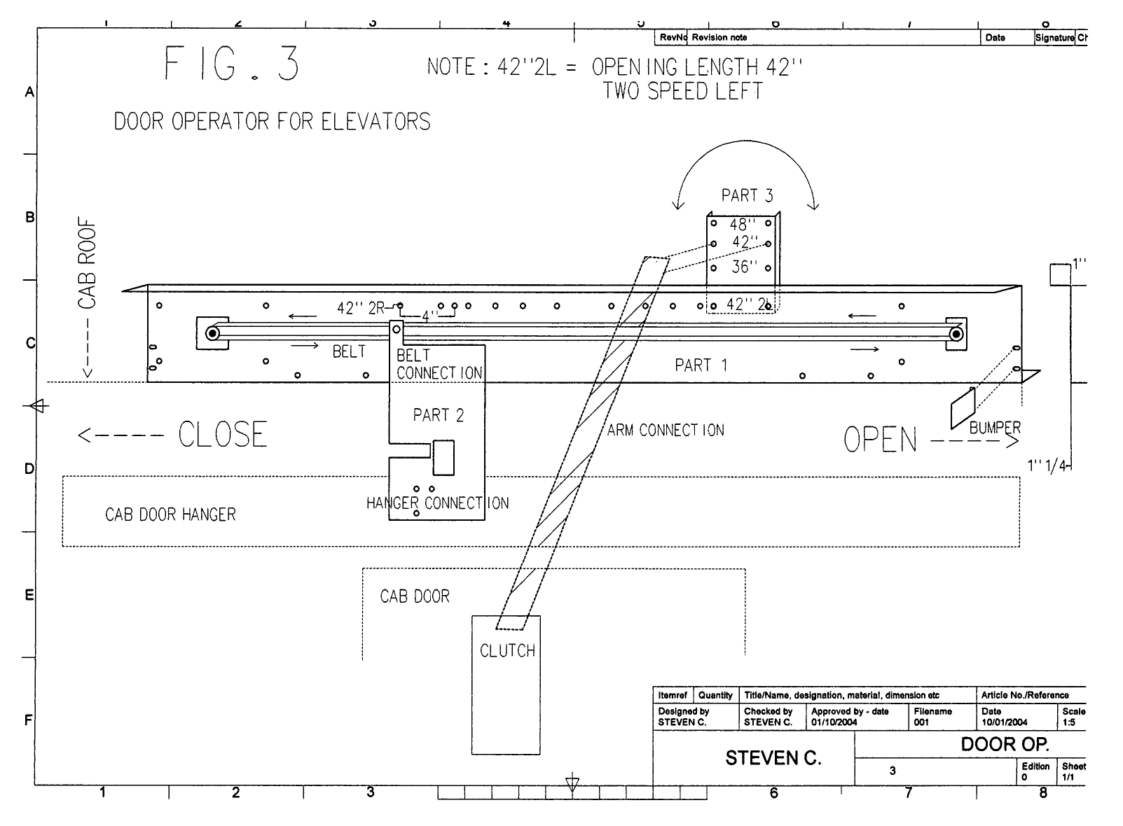

Also where the arm connection to the clutch and [part 3] are done for a 42″ (inches) opening length, two speed and left side.

### DETAILED DESCRIPTION

The [part 1, see drawings] has three pair of combinations [36″; 42″; 48″] Opening lengths with [right or left] opening sides. This [part 1] has several holes design for elevators openings depending On the quantity of passengers it will take. From the holes you attach by screwing [part 3] to [part 1] this part Is necessary to connect the arm that connects to the clutch The clutch is necessary to open the hall doors. The [part 2, see drawings] is connected to the belt and to the cab door hanger That opens and close the door. The [part 2] is screw to the hanger rollers where the cab door is hang. The bumper is necessary so [part 2, see drawings] is limited to open completely. The difference between one speed and two speed is the dimension the elevator Hoist way has to hide the doors once they are open completely. One speed is equal the door length to the opening length. Two speed is equal the door length to half the opening length. Depending the opening length, side and speed the selection is done on [part 1 ,see drawings] and [part 3 ,see drawings]. [part 2 ,see drawings] is always the same connection for all the combinations To the belt and the car door hanger. The bumper only depends on the side of the opening [right or left].

1. An door operator for elevator which [part 1,see drawings] has several holes and dimensions useful to select the opening side and length.

2. An [part 1,see drawings] according to claim 1, wherein the opening length can be 36″; 42″ or 48″ and right or left the opening side.

3. An [part 2,see drawings] that is design to connect the cab door with the belt.

4. An [part 3,see drawings] that is useful for the arm connection to the clutch ,also selectable depending the opening length.
